(19) United States
(12) Patent Application Publication
(10) Pub. No.: US 2023/0211617 A1
(43) Pub. Date: Jul. 6, 2023

(54) PRINTERS INCLUDING A FAN CONTROLLING UNIT

(71) Applicant: Hewlett-Packard Development Company, L.P., Spring, TX (US)

(72) Inventors: Volker SEIDEL, Sant Cugat del Valles (ES); Albert FRANCO MORERA, Sant Cugat del Valles (ES); Lluis CORTES MOCHALES, Sant Cugat del Valles (ES)

(73) Assignee: Hewlett-Packard Development Company, L.P., Spring, TX (US)

(21) Appl. No.: 17/999,251

(22) PCT Filed: May 19, 2020
(86) PCT No.: PCT/US2020/033529

§ 371 Date: Nov. 18, 2022

(51) Int. Cl. B41J 11/00; B41J 29/377

(52) U.S. Cl. CPC B41J 11/00222; B41J 29/377

(57) ABSTRACT

A printer includes a print zone, a curing zone, first and second fans, a heat exchanger, a heat valve, and a fan controlling unit. The print zone includes a print head to lay down ink on a media. The curing zone treats the media. The first fan generates a primary flow through the curing zone to treat the media. The heat exchanger is downstream the curing zone on the primary flow to condensate vapors contained in the primary flow. The second fan generate as secondary flow through the heat exchanger to cool the primary flow. The secondary flow is able to reach the print zone. The heat valve releases the secondary flow into the environment, downstream the heat exchanger. The fan controlling unit controls the second fan taking into account an ink density of the ink laid down on the media and/or an aperture level of the heat valve.

### BACKGROUND

Printers generally include a print zone wherein ink is laid down on a media and a curing zone for treating the media. The media may be passed through the curing zone after it has passed through the print zone. A warm air flow may be generated through the curing zone to dry and fix the ink on the media. By doing so, water and solvent contents of the ink may be evaporated. In some printers, these vapors may be liquefied in a heat exchanger.

### BRIEF DESCRIPTION OF THE DRAWINGS

FIG. 1 is a schematic view of a printer according to an example of the present disclosure.

FIG. 2 is a sideview of a printing apparatus according to another example of the present disclosure.

FIG. 3 is a flowchart of an example printing method of the present disclosure.

FIG. 4 is a graph illustrating a controlling step of the example printing method of FIG. 3.

### DETAILED DESCRIPTION

In one example, a fan controlling unit is to control the fan providing the heat exchanger with an airflow to cool the vapors generated through the curing zone. In order to improve the vapor condensation performance while reducing fan noise, the control may be implemented taking into account an ink density of the ink laid down on the media and/or an aperture level of a heat valve.

In one example, the fan controlling unit is to increase the pulse width modulation of the fan after the heat valve is being closed, and the valve is being opened after the fan controlling unit decreases the pulse width modulation of the fan. This allows avoiding noise surge during the valve operation.

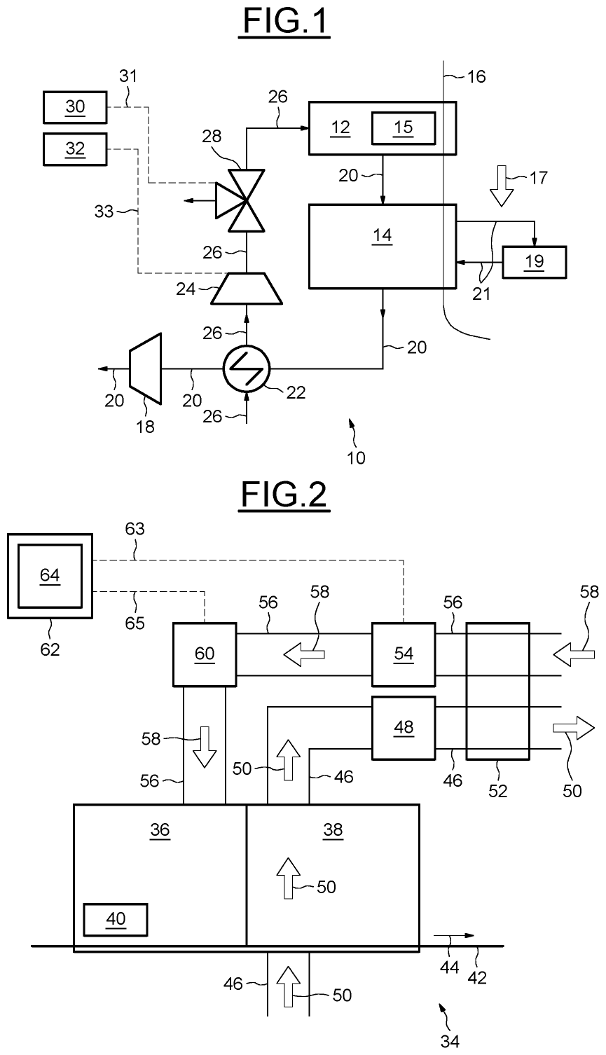

In one example, which is depicted on FIG. 1, a printer 10 includes a print zone 12 and a curing zone 14. The print zone 10 may accommodate a print head 15.

A media 16 may be passed, successively, through the print zone 12 and the curing zone 14. The media 16 may follow a media advance direction 17. In the print zone 12, the print head 15 may lay down ink on the media 16. Then, the ink laid down on the media 16 may dry and fix in the curing zone 14.

The printer 10 may include an extraction fan 18. The extraction fan 18 may generate a primary flow 20 through the curing zone 14. The primary flow 20 may include air coming from the print zone 12. The primary flow 20 may be heated by means of a heater 19 and a loop 21. Hence, part of the primary flow 20 located in the curing zone 14 may be collected by the loop 21, passed through the heater 19 and injected in the curing zone 14. Hence, the primary heated airflow 20 may evaporate water and solvent contents of the ink laid down on the media 16 passing through the curing zone 14. Downstream the curing zone 14, the primary flow 20 may thus include vapors such as water vapors or organic solvents vapors.

The printer 10 may include a heat exchanger 22 located downstream the curing zone 14 on the primary flow 20. The heat exchanger 22 may be a crossflow exchanger.

The printer 10 may include a crossflow fan 24. The fan 24 may generate a secondary flow 26 through the heat exchanger 22. The secondary flow 26 may include cold ambient air. Hence, the heat exchanger 22 may be supplied with the secondary cold air flow 26 to condensate the vapors contained in the primary flow 20. The temperature of the secondary cold air flow 26 may be the ambient air temperature and/or a temperature lower than the temperature of the air within the curing zone 14. The temperature of the secondary cold air flow 26 may be between 15° C. and 30° C.

Downstream the fan 24, the secondary flow 26 may reach the print zone 12. By virtue of this arrangement, a temperature in the print zone 12 may be increased using the secondary flow 26 heated by the heat exchanger 22.

To regulate the temperature in the print zone 12, the printer 10 may include a heat valve 28 located on the secondary flow 26, between the fan 24 and the print zone 12. After it has reached the print zone 12, the secondary flow 26 may form at least part of the primary flow 20. If, due to the opening of the valve 28, the secondary flow 26 does not provide enough air to form the primary flow 20, the primary flow 20 may be formed by ambient air entering the print zone 12 or the curing zone 14, for instance via leakages.

The printer 10 may include a valve controlling unit 30. The valve controlling unit 30 may be in data communication with the heat valve 28, as shown by the line 31. The data communication 31 may be implemented by means of a wired connection or a wireless connection. The valve controlling unit 30 may close the heat valve 28, so that the flow reaches the print zone 12 and the temperature inside the print zone 12 is increased. Otherwise, the valve controlling unit 30 may open the valve 28 to release the secondary flow 26 into the environment. Hence, under normal ambient temperature conditions, the temperature inside the print zone 12 may decrease by itself as no hot air is injected anymore.

The printer 10 may include a fan controlling unit 32. The fan controlling unit 32 may be in data communication with the fan 24, as shown by the arrow 33. The data communication 33 may be implemented by means of a wired connection or a wireless connection. The fan controlling unit 32 may control the duty of the fan 24. To do so, the fan controlling unit 32 can control the pulse width modulation, or PWM, of the fan 24. The duty of the fan 24 may be proportional to the PWM of the fan 24. The fan controlling unit 32 may take into account an ink density of the ink laid down on the media 16 in the print zone 12. The fan controlling unit 32 may, additionally or as an alternative, take into account an aperture level of the heat valve 28.

If the ink density of the ink laid down on the media 16 is high, vapors in the primary flow 20 are in high saturation conditions and may be condensed when passing the dew point in the heat exchanger 22. By comparison, if the ink density is poor, when reducing the temperature of the primary flow 20, first the relative humidity rises until liquid condensates are formed once passing the saturation point. Hence, the performance of the heat exchanger 22 to condense is higher in saturated conditions than in not saturated conditions. When the condensation performance is poor, the duty of the crossflow fan 24 may be reduced whereas when the ink density is high, the duty of the crossflow fan 24 needs to be maximized to improve condensation. When the ink density on the media 16 is high, the duty of the crossflow fan 24 may equal the duty corresponding to the noise limit or be slightly lower than the duty corresponding to the noise limit. The crossflow fan 24 may be controlled as to maintain the noise below or at a determined noise limit.

When the heat valve 28 is closed, the duty of the crossflow fan 24 may be further increased. When the heat valve 28 is closed, the secondary flow 26 may reach the print zone 12 and the pressure drop downstream the crossflow fan 24 is increased. Hence, to maintain the mass flow of the secondary flow 26 and to maintain condensation performance when the heat valve 28 is closed, the fan controlling unit 32 may increase the duty of the crossflow fan 24. In the meantime, when the heat valve 28 is closed, the noise emitted by the printer 10 due to the crossflow fan 24 decreases. Hence, the increase of the duty of the crossflow fan 24 when the heat valve 28 is closed is possible without having the printer unrespecting the noise limits. When the heat valve 28 opens, the noise increases and the duty of the crossflow fan 24 may be decreased because the pressure drop is reduced and the same mass flow may be obtained with a lower fan duty.

In another example, which is depicted on FIG. 2, a printing apparatus 34 includes a print chamber 36 and a curing chamber 38. The print chamber 36 may include a print head 40 which may eject ink onto a substrate 42. The substrate 42 may first pass through the print chamber 36 and, then, pass through the curing chamber 38. In other words, the substrate 42 may move along the substrate advance direction 44.

The printing apparatus 34 may include a path 46. The curing chamber 38 may be located on the path 46. A blower 48 may be located on the path 46 and may feed the path 46 with a warm flow 50 to provide the substrate 42 with thermal energy by convection. By doing so, ink ejected onto the substrate 42 may dry by evaporating water and solvent contents. The vapors are extracted from the curing chamber 38 with the flow 50, thus forming a vapor flow 50.

The printing apparatus 34 may include a cooler 52 located on the path 46. The cooler 52 may include a path 56 and a blower 54 mounted on the path 56. Hence, the blower 54 may feed the path 56 with a cool airflow 58. The airflow 58 may circulate inside the cooler 52 and may cool the vapor flow 50. The airflow 58 may condensate vapors contained in the vapor flow 50. Downstream the cooler 52, the temperature of the airflow 58 may be high due to thermal exchanges with the vapor flow 50.

The path 56 may lead the airflow 58 to the print chamber 36. The printing apparatus 34 may include a thermal energy discharge vane 60. The vane 60 may be mounted on the path 56 between the blower 54 and the print chamber 36. The vane 60 may be actuated in a closed state wherein it directs the airflow 58 to the print chamber 36, thus increasing a temperature inside the print chamber 36. The vane 60 may be actuated in an open state wherein it directs the airflow 58 towards the atmosphere. In such case and under normal ambient temperature conditions, the temperature inside the print chamber 36 may decrease.

The printing apparatus 34 may include a controller 62. The controller 62 may have a data connection 65 with the vane 60. The controller 62 may have a data connection 63 with the blower 54. The controller 62 may control the vane 60 and the blower 54. The controller 62 may control the vane 60 to regulate a temperature of the print chamber 36 around a target temperature.

The controller 62 may control the PWM of the blower 54. The controller 62 may include a lookup table 64 containing PWM values as a function of an ink density on the substrate 42 and an opening state of the vane 60.

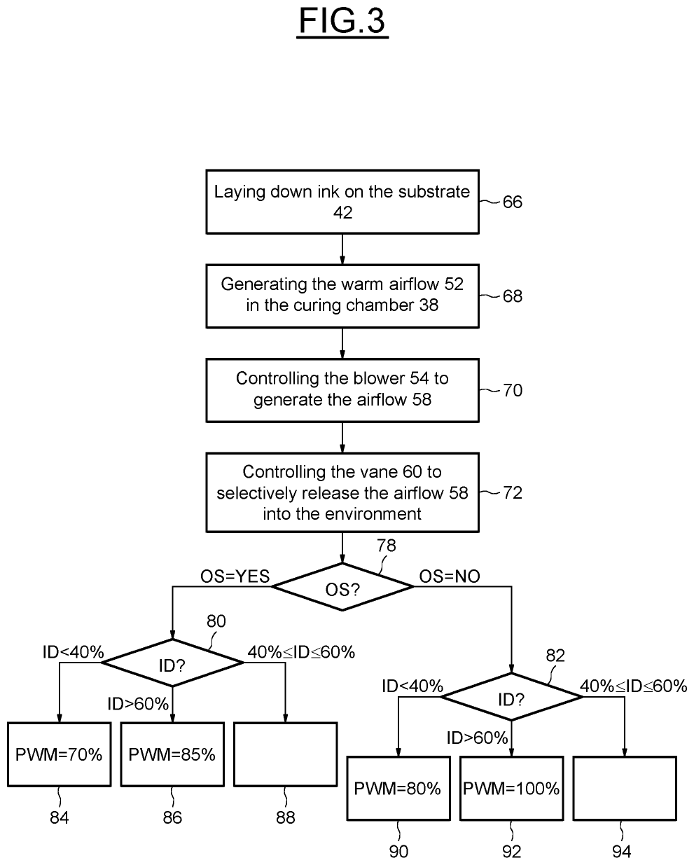

In one example, which is depicted in FIG. 3, a printing method which may be implemented by means of the example printing apparatus 34 of FIG. 2 will now be detailed.

The example method of FIG. 3 may be implemented regularly, for instance every five seconds when the printing apparatus 34 is operated.

The example method may include, at block 66, laying down the ink on the substrate 42 in the print chamber 36. To do so, the print head 40 may eject an amount of ink onto the substrate 42. This amount of ink may be recorded by the controller 62.

The example method may include, at block 68, generating the warm airflow 52 in the curing chamber 38. When the substrate 42 is heated by the warm airflow 50, the ink is dried on the substrate 42 and water and solvents are evaporated and extracted from the curing chamber 38 with a warm airflow 50.

The example method may include, at block 70, controlling the blower 54 to generate the airflow 58. Hence, the airflow 58 may cool the warm airflow 50 and vapors contained in the warm airflow 50 may then be liquefied. After it has cooled the warm airflow 50, the airflow 58 has an increased temperature and may reach the print chamber 36.

The example method may include, at block 72, a step of controlling the vane 60 to selectively release the airflow 58 into the environment. During this step, the controller 62 may control the opening state of the vane 60 to regulate the temperature of the print chamber 36.

As will be detailed later, the controller 62 may enter in the lookup table 64 an ink density ID corresponding to the amount of ink ejected by the print head 40 at block 66, and the opening state OS of the vane 60 controlled at block 72, and collect a PWM value issued by the lookup table 64.

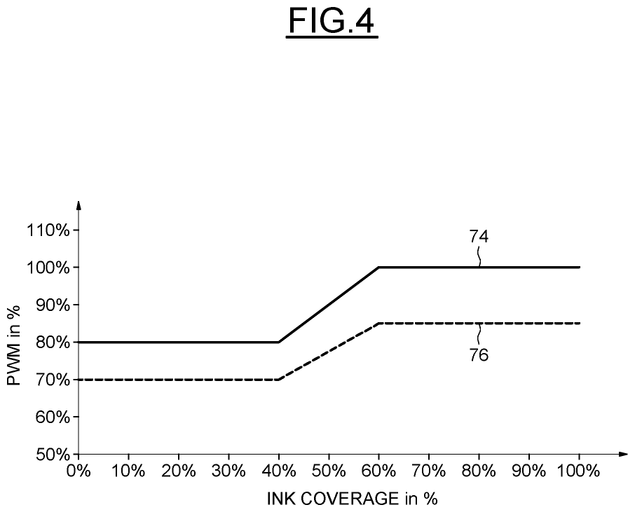

A graph illustrating the lookup table 64 of the example printing apparatus 34 and used for implementing the printing method of FIG. 3 is shown on FIG. 4. The graph includes a plot of PWM values as a function of the ink density. The PWM values may be given as a percentage of a rated PWM, which may correspond to a PWM value wherein the blower 54 operates at optimal conditions while respecting the noise limits when the vane 60 is closed.

The graph of FIG. 4 may include a first plot 74 including PWM values to be set on the blower 54 when the vane 60 is closed. The graph of FIG. 4 may include a second plot 76, in dashed lines, including PWM values for the blower 54 when the vane 60 is open.

The graph of FIG. 4 may be used for determining the PWM value of the blower 54 to be set in accordance with the opening state OS and the ink density ID in the steps 78 to 94, as will be explained later.

Referring back to FIG. 3, to adjust the PWM of the blower 54, the example method may include a first test step 78 wherein the opening state OS of the vane 60 is monitored. If, at step 78, it is determined that the vane 60 is open, the opening state OS may be “Yes” and a step 80 may be implemented. If, at step 78, the vane 60 is closed, the opening state OS may equal “No” and a step 82 may be implemented. Although the opening state OS may take any value within 0% and 100%, one may consider that the vane 60 is closed when the angle of the vane 60 is below 5%, and open when the angle of the vane 60 is above 5%.

During the step 80, one may monitor the ink density ID of the ink laid down on the substrate 42 with reference with thresholds which may be 40% and 60%. If, at step 80, the ink density ID is below 40%, the example method may include a control step 84 wherein the PWM of the blower 54 is set to 70%. If, at step 80, the ink density ID is above 60%, the example method may include a control step 86 wherein the PWM of the blower 54 is set to 85%.

If, at step 80, the ink density ID is within 40% to 60%, then the example method may include a control step 88 wherein the PWM takes a value between 70% and 85%. As visible on FIG. 4, the PWM value may be obtained by implementing a linear interpolation between 40% on 60%.

During the step 82, one may monitor the ink density ID of the ink laid down on the substrate 42. One may use the same thresholds as during the step 80. If, at step 82, the ink density ID is below 40%, the example method may include a control step 90 wherein the PWM of the blower 54 is set to 100%. If, at step 82, the ink density ID is above 60%, the example method may include a control step 92 wherein the PWM of the blower 54 is set to 100%. If, at step 82, the ink density ID is between 40% and 60%, the example method may include a control step 94 wherein the PWM of the blower 54 is set to a variable value between 80% and 100%.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A printer including:
a print zone including a print head to lay down ink on a media,
a curing zone to treat the media when it arrives from the print zone,
a first fan to generate a primary flow through the curing zone to treat the media,
a heat exchanger downstream the curing zone on the primary flow to condensate vapors contained in the primary flow,
a second fan to generate a secondary flow through the heat exchanger to cool the primary flow, the secondary flow being able to reach the print zone,
a heat valve to release at least partially the secondary flow into the environment, downstream the heat exchanger, and
a fan controlling unit to control the second fan taking into account an ink density of the ink laid down on the media and/or an aperture level of the heat valve.

2. The printer of claim 1, including a valve controlling unit to control the aperture level of the heat valve in order to regulate a temperature inside the print zone.

3. The printer of claim 1, wherein the fan controlling unit is to control a pulse width modulation of the second fan.

4. The printer of claim 1, wherein the fan controlling unit is to increase the pulse width modulation of the second fan if the ink density of the ink laid down on the media increases.

5. The printer of claim 1, wherein the fan controlling unit is to increase the pulse width modulation of the second fan if the ink density of the ink laid down on the media is more than a first threshold within a range 40% to 70%, and to decrease the pulse width modulation of the second fan if the ink density of the ink laid down on the medial is less than the first threshold.

6. The printer of claim 1, wherein the fan controlling unit is to increase the pulse width modulation of the second fan when the heat valve is being closed.

7. The printer of claim 1, wherein the fan controlling unit is to increase the pulse width modulation of the second fan if the aperture level of the heat valve is below a second threshold within a range 3% to 8%, and to decrease the pulse width modulation of the second fan if the aperture level of the heat valve is above the second threshold.

8. A printing apparatus including:
a print chamber comprising a print head to eject ink onto a substrate,
a curing chamber to receive the substrate coming from the print chamber,
a first path leading to the curing chamber,
a first blower to feed the first path with warm air to provide the substrate with thermal energy,
a cooler downstream the curing chamber on the first path to condensate vapors of air circulating through the first path, the cooler including a second path and a second blower to feed the second path with cold air to cool air circulating through the first path, and wherein the second path leads to the print chamber,
a thermal energy discharge vane located on the second path between the cooler and the print chamber, and
a controller to control the second blower as a function of the ink density of the ink ejected by the print head and/or of an opening state of the thermal energy discharge vane.

9. The printing apparatus of claim 8, wherein the controller is to control a pulse width modulation of the second blower.

10. The printing apparatus of claim 8, wherein the controller is to increase a speed setpoint of the second blower if the ink density of the ink ejected by the print head increases.

11. The printing apparatus of claim 8, wherein the controller is to increase a speed setpoint of the second blower when the thermal energy discharge vane is being closed.

12. The printing apparatus of claim 8, wherein the controller includes a look up table to provide a high speed setpoint if the ink density of the ink ejected by the print head is more than a first reference value, and to provide a low speed setpoint if the ink density of the ink ejected by the print head is less than a second reference value, the second reference value being lower than the first reference value.

13. The printing apparatus of claim 12, wherein the look up table is to provide a variable speed setpoint if the ink density of the ink ejected by the print head is between the first reference value and the second reference value.

14. The printing apparatus of claim 11, wherein, for any value of the ink ejected by the print head, the look up table is to issue a first speed setpoint to be used if the thermal energy discharge vane is open and a second speed setpoint if the thermal energy discharge vane is closed, the second speed setpoint being equal to the first speed setpoint multiplied by a coefficient within a range 1.1 and 1.2.

15. A printing method including:
laying down ink on a media in a print zone,
generating a primary flow to heat the media,
controlling a fan to generate a secondary flow cooling the primary flow, the secondary flow being able to reach the print zone,
controlling a heat valve to release at least partially the secondary flow path into the environment, after it has cooled the primary flow and before it reaches the print zone,
wherein the fan is controlled taking into account an ink density of the ink laid down on the media and/or an aperture level of the heat valve.
